(19) United States
(12) Patent Application Publication
(10) Pub. No.: US 2025/0370216 A1
(43) Pub. Date: Dec. 4, 2025

(54) CAMERA MODULE INCLUDING ACTUATOR

(71) Applicant: SAMSUNG ELECTRONICS CO., LTD., Suwon-si (KR)

(72) Inventors: Jiyeon JO, Suwon-si (KR); Jaekyu SHIM, Suwon-si (KR)

(73) Assignee: SAMSUNG ELECTRONICS CO., LTD., Suwon-si (KR)

(21) Appl. No.: 19/201,233

(22) Filed: May 7, 2025

Related U.S. Application Data
(63) Continuation of application No. PCT/KR2025/099746, filed on Mar. 13, 2025.

(30) Foreign Application Priority Data
May 28, 2024 (KR) 10-2024-0069546
Jun. 19, 2024 (KR) 10-2024-0079502

(51) Int. Cl. G02B 7/09; G03B 13/36

(52) U.S. Cl. CPC G02B 7/09; G03B 13/36

(57) ABSTRACT

The camera module includes a lens having an optical axis; a carrier configured to carry the lens in a direction along the optical axis; a camera housing accommodating the carrier; a first magnet in the carrier and offset from the optical axis in a first direction substantially orthogonal to the optical axis; a second magnet in the carrier and offset from the optical axis in a second direction substantially orthogonal to the optical axis; a first coil configured to be electromagnetically coupled with the first magnet; a second coil configured to be electromagnetically coupled with the second magnet; a first yoke facing the first magnet; a second yoke facing the second magnet; and at least three balls between the carrier and the camera housing and configured to support the carrier with respect to the camera housing and to guide the carrier in the direction along the optical axis.

### CROSS-REFERENCE TO RELATED APPLICATIONS

This application is a continuation application of International Application No. PCT/KR2025/099746 designating the United States, filed on Mar. 13, 2025, in the Korean Intellectual Property Receiving Office and claiming priority to Korean Patent Application No. 10-2024-0069546, filed on May 28, 2024, and Korean Patent Application No. 10-2024-0079502, filed on Jun. 19, 2024, in the Korean Intellectual Property Office, the disclosures of which are incorporated by reference herein in their entireties.

### BACKGROUND

### 1. Field

The disclosure generally relates to a camera module, for example, a camera module including an actuator, and an electronic device including the camera module.

### 2. Description of Related Art

An actuator is being developed to move a lens along an optical axis to implement autofocus in a camera module. For example, the lens may be actuated using a spring, a ball, a shape memory alloy (SMA) wire, or any other actuator.

The above description has been possessed or acquired by the inventor(s) in the course of conceiving the present disclosure and is not necessarily an art publicly known before the present application is filed.

### SUMMARY

According to an aspect of the disclosure, a camera module includes: a lens having an optical axis; a carrier configured to carry the lens in a direction along the optical axis; a camera housing configured to accommodate the carrier; a first magnet in the carrier and offset from the optical axis in a first direction substantially orthogonal to the optical axis; a second magnet in the carrier and offset from the optical axis in a second direction different from the first direction and substantially orthogonal to the optical axis; a first coil in the camera housing and configured to be electromagnetically coupled with the first magnet; a second coil in the camera housing and configured to be electromagnetically coupled with the second magnet; a first yoke in the camera housing and facing the first magnet; a second yoke in the camera housing and facing the second magnet; and at least three balls between the carrier and the camera housing, wherein the at least three balls are configured to support the carrier with respect to the camera housing and to guide the carrier in the direction along the optical axis.

According to an aspect of the disclosure, a camera module includes: a lens having an optical axis; a carrier configured to carry the lens in a direction along the optical axis; a camera housing configured to accommodate the carrier; a first magnet in the carrier and offset from the optical axis in a first direction substantially orthogonal to the optical axis; a second magnet in the carrier and offset from the optical axis in a second direction different from the first direction and substantially orthogonal to the optical axis; a first coil in the camera housing and configured to be electromagnetically coupled with the first magnet; a second coil in the camera housing and configured to be electromagnetically coupled with the second magnet; a first yoke in the camera housing and facing the first magnet; a second yoke in the camera housing and facing the second magnet; at least one ball configured to guide the carrier with respect to the camera housing in the direction along the optical axis; and a shaft configured to guide the carrier with respect to the camera housing in the direction along the optical axis.

According to an aspect of the disclosure, an electronic device includes: memory storing one or more instructions; at least one processor configured to execute the one or more instructions; a camera module including: a lens having an optical axis; a carrier configured to carry the lens in a direction along the optical axis; a camera housing configured to accommodate the carrier; a first magnet in the carrier and offset from the optical axis in a first direction substantially orthogonal to the optical axis; a second magnet in the carrier and offset from the optical axis in a second direction different from the first direction and substantially orthogonal to the optical axis; a first coil in the camera housing and configured to be electromagnetically coupled with the first magnet; a second coil in the camera housing and configured to be electromagnetically coupled with the second magnet; a first yoke in the camera housing and facing the first magnet; a second yoke in the camera housing and facing the second magnet; at least three balls between the carrier and the camera housing; and an image sensor configured to obtain an image by converting light received through the lens into an electrical signal, wherein the at least three balls are configured to support the carrier with respect to the camera housing and to guide the carrier in the direction along the optical axis, and wherein the one or more instructions, when executed by the at least one processor, cause the electronic device to control movement of the carrier in the direction along the optical axis by controlling a flow of current applied to the first coil and the second coil.

### BRIEF DESCRIPTION OF THE DRAWINGS

The above and other aspects features, and advantages of certain embodiments of the present disclosure will be more apparent from the following detailed description, taken in conjunction with the accompanying drawings, in which:

FIG. 1 is a block diagram illustrating an electronic device in a network environment according to one or more embodiments;

FIG. 2 is a block diagram illustrating a camera module according to one or more embodiments;

FIG. 3 is a perspective view of an electronic device in one direction according to one or more embodiments;

FIG. 4 is a perspective view of the electronic device in another direction according to one or more embodiments;

FIG. 5 is a perspective view of a camera module according to one or more embodiments;

FIG. 6 is a plan view of a camera module according to one or more embodiments;

FIG. 7 is a side view of a camera module according to one or more embodiments;

FIG. 8 is an exploded perspective view of a camera module according to one or more embodiments;

FIG. 9 is a cross-sectional view of the camera module along line 9-9 of FIG. 6 according to one or more embodiments;

FIG. 10 is a cross-sectional view of the camera module along line 10-10 of FIG. 7 according to one or more embodiments;

FIG. 11 is a cross-sectional view of a camera module according to one or more embodiments;

FIG. 12 is a side view of a camera module according to one or more embodiments;

FIG. 13 is a plan view of a camera module according to one or more embodiments;

FIG. 14 is a cross-sectional view of a damper of a camera module according to one or more embodiments;

FIG. 15 is a perspective view of a magnet and a yoke of a camera module according to one or more embodiments;

FIG. 16 is a perspective view of a magnet and a yoke of a camera module according to one or more embodiments; and

FIG. 17 is a cross-sectional view of a camera module according to one or more embodiments.

### DETAILED DESCRIPTION

Hereinafter, certain embodiments will be described in detail with reference to the accompanying drawings. When describing the embodiments with reference to the accompanying drawings, like reference numerals refer to like elements and a repeated description related thereto will be omitted.

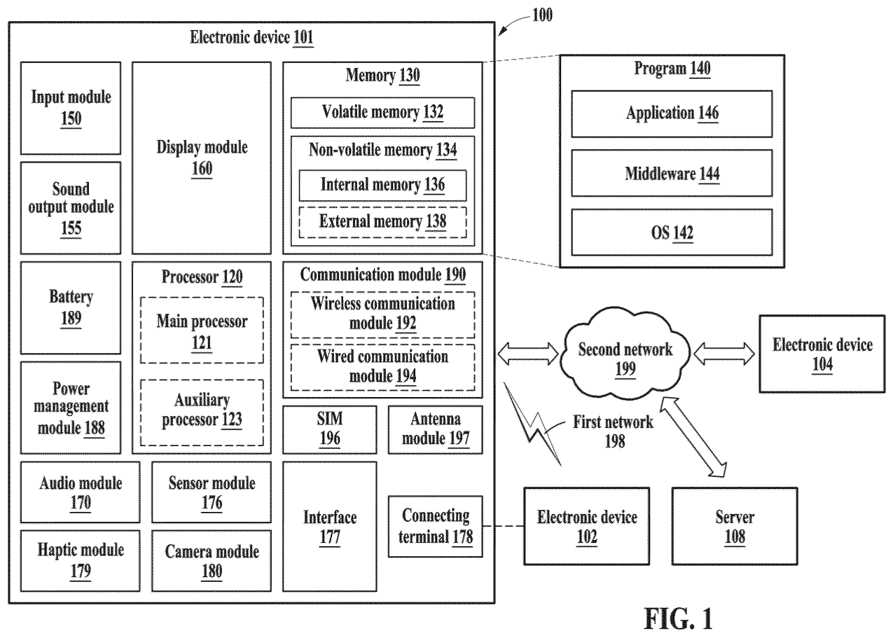

FIG. 1 is a block diagram of an electronic device in a network environment according to one or more embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to one or more embodiments, the electronic device 101 may communicate with the electronic device 104 via the server 108. According to one or more embodiments, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiments, at least one (e.g., the connecting terminal 178) of the above components may be omitted from the electronic device 101, or one or more other components may be added to the electronic device 101. In one or more embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to one or more embodiments, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to one or more embodiments, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to one or more embodiments, the auxiliary processor 123 (e.g., an ISP or a CP) may be implemented as a portion of another component (e.g., the camera module 180 or the communication module 190) that is functionally related to the auxiliary processor 123. According to one or more embodiments, the auxiliary processor 123 (e.g., an NPU) may include a hardware structure specified for artificial intelligence (AI) model processing. The AI model may be generated by machine learning. Such learning may be performed, for example, by the electronic device 101 in which an artificial intelligence model is executed, or via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a DNN, a convolutional neural network (CNN), an RNN, a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a record. The receiver may be used to receive an incoming call. According to one or more embodiments, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to one or more embodiments, the display module 160 may include a touch sensor adapted to sense a touch, or a pressure sensor adapted to measure an intensity of a force incurred by the touch.

The audio module 170 may convert a sound into an electric signal and vice versa. According to one or more embodiments, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to one or more embodiments, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to one or more embodiments, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to one or more embodiments, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to one or more embodiments, the haptic module 179 may include, for example, a motor, a piezoelectric element, or an electric stimulator.

The camera module 180 may capture a still image and moving images. According to one or more embodiments, the camera module 180 may include one or more lenses, image sensors, ISPs, or flashes.

The power management module 188 may manage power supplied to the electronic device 101. According to one or more embodiments, the power management module 188 may be implemented as, for example, at least a portion of a power management integrated circuit (PMIC).

The battery 189 may supply power to at least one component of the electronic device 101. According to one or more embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to one or more embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide region network (WAN)). These various types of communication modules may be implemented as a single component (e.g., a single chip), or may be implemented as multiple components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mm Wave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to one or more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to one or more embodiments, the antenna module 197 may include an antenna including a radiating element including a conductive material or a conductive pattern formed in or on a substrate (e.g., a printed circuit board (PCB)). According to one or more embodiments, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to one or more embodiments, another component (e.g., a radio frequency integrated circuit (RFIC)) other than the radiating element may be additionally formed as a portion of the antenna module 197.

According to one or more embodiments, the antenna module 197 may form a mmWave antenna module. According to one or more embodiments, the mm Wave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiments, commands or data may be transmitted or received between the electronic device 101 and the external electronic device 104 via the server 108 coupled with the second network 199. Each of the external electronic devices 102 and 104 may be a device of the same type as or a different type from the electronic device 101. According to one or more embodiments, all or some of operations to be executed at the electronic device 101 may be executed at one or more of external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To this end, cloud computing, distributed computing, mobile edge computing (MEC), or client-server computing technology may be used, for example. The electronic device 101 may provide ultra-low-latency services using, e.g., distributed computing or mobile edge computing. In one or more embodiments, the external electronic device 104 may include an Internet-of-things (IoT) device. The server 108 may be an intelligent server using machine learning and/or a neural network. According to one or more embodiments, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to the embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. According to one or more embodiments of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1^{st},” and “2^{nd},” or “first” and “second” may be used to simply distinguish a corresponding component from another, and do not limit the components in other aspect (e.g., importance or order). It is to be understood that if a component (e.g., a first component) is referred to, with or without the term “operatively” or “communicatively,” as “coupled with,” “coupled to,” “connected with,” or “connected to” another component (e.g., a second component), the component may be coupled with the other component directly (e.g., by wire), wirelessly, or via a third component.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiments, a method according to one or more embodiments disclosed herein may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

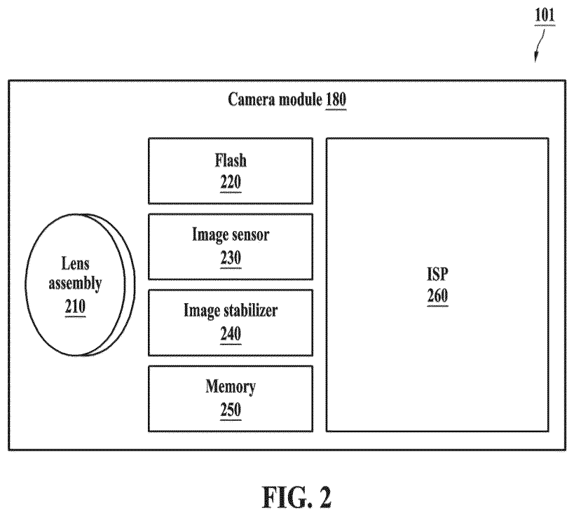

FIG. 2 is a block diagram illustrating a camera module according to one or more embodiments.

Referring to FIG. 2, the camera module 180 may include a lens assembly 210, a flash 220, an image sensor 230, an image stabilizer 240, a memory 250 (e.g., a buffer memory), or an ISP 260. The lens assembly 210 may collect light emitted from an object that is a target from which an image is to be captured. The lens assembly 210 may include one or more lenses. According to one or more embodiments, the camera module 180 may include a plurality of lens assemblies 210. In this case, the camera module 180 may constitute, for example, a dual camera, a 360-degree camera, or a spherical camera. A portion of the lens assemblies 210 may have the same lens properties (e.g., an angle of view, a focal length, an autofocus, an f number, or an optical zoom), or at least one lens assembly may have one or more lens properties that are different from those of another lens assembly. The lens assembly 210 may include, for example, a wide-angle lens or a telephoto lens.

The flash 220 may emit light to be used to enhance light emitted or reflected from the object. According to one or more embodiments, the flash 220 may include one or more light-emitting diodes (LEDs) (e.g., a red-green-blue (RGB) LED, a white LED, an IR LED, or an ultraviolet (UV) LED), or a xenon lamp. The image sensor 230 may obtain an image corresponding to the object by converting light emitted or reflected from the object and transmitted through the lens assembly 210 into an electrical signal. According to one or more embodiments, the image sensor 230 may include, for example, one image sensor selected from among image sensors having different properties, such as, for example, an RGB sensor, a black and white (BW) sensor, an IR sensor, or a UV sensor, a plurality of image sensors having the same property, or a plurality of image sensors having different properties. Each image sensor included in the image sensor 230 may be implemented using, for example, a charged coupled device (CCD) sensor or a complementary metal-oxide-semiconductor (CMOS) sensor.

The image stabilizer 240 may move at least one lens included in the lens assembly 210 or the image sensor 230 in a specific direction, or control an operation characteristic (e.g., adjust the read-out timing) of the image sensor 230, in response to a movement of the camera module 180 or the electronic device 101 including the camera module 180. This may compensate for at least a portion of a negative effect of the movement on an image to be captured. According to one or more embodiments, the image stabilizer 240 may sense such a movement of the camera module 180 or the electronic device 101 using a gyro sensor or an acceleration sensor disposed inside or outside the camera module 180. According to one or more embodiments, the image stabilizer 240 may be implemented as, for example, an optical image stabilizer. The memory 250 may at least temporarily store at least a portion of the image obtained through the image sensor 230 for a subsequent image processing task. For example, when image acquisition is delayed by a shutter or a plurality of images are obtained at a high speed, an obtained original image (e.g., a Bayer-patterned image or a high-resolution image) may be stored in the memory 250, and a copy image (e.g., a low-resolution image) corresponding the original image may be previewed through the display module 160. Subsequently, when a specified condition (e.g., a user input or a system command) is satisfied, at least a portion of the original image stored in the memory 250 may be obtained and processed by, for example, the ISP 260. According to one or more embodiments, the memory 250 may be configured as at least part of the memory 130 or as a separate memory operated independently of the memory 130.

The ISP 260 may perform one or more image processing operations on the image obtained through the image sensor 230 or the image stored in the memory 250. The image processing operations may include, for example, depth map generation, three-dimensional (3D) modeling, panorama generation, feature point extraction, image synthesis, or image compensation (e.g., noise reduction, resolution adjustment, brightness adjustment, blurring, sharpening, or softening). Additionally or alternatively, the ISP 260 may control at least one of the components (e.g., the image sensor 230) included in the camera module 180 (e.g., control an exposure time, control a read-out timing, or the like). The image processed by the ISP 260 may be stored again in the memory 250 for further processing or may be provided to an external component (e.g., the memory 130, the display module 160, the electronic device 102, the electronic device 104, or the server 108) of the camera module 180. According to one or more embodiments, the ISP 260 may be configured as at least part of the processor 120 or as a separate processor operated independently of the processor 120. When the ISP 260 is configured as a processor separate from the processor 120, at least one image processed by the ISP 260 may be displayed as it is or be displayed through the display module 160 after additional image processing is performed by the processor 120.

According to one or more embodiments, the electronic device 101 may include a plurality of camera modules 180 having different properties or functions. In this case, for example, at least one of the plurality of camera modules 180 may be a wide-angle camera, and at least another one of the plurality of camera modules 180 may be a telephoto camera. Similarly, at least one of the plurality of camera modules 180 may be a front camera, and at least another one of the plurality of camera modules 180 may be a rear camera.

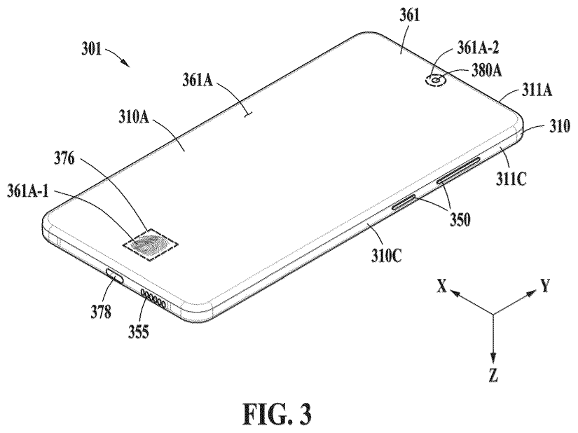

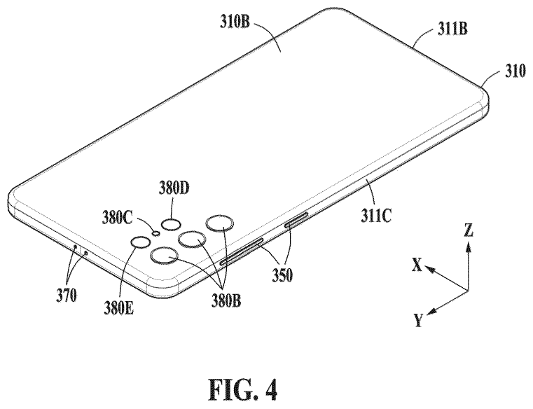

FIG. 3 is a perspective view of an electronic device in one direction according to one or more embodiments. FIG. 4 is a perspective view of the electronic device in another direction according to one or more embodiments.

Referring to FIGS. 3 and 4, an electronic device 301 (e.g., the electronic device 101 of FIG. 1) may include a housing 310 including a first surface 310A (e.g., a front surface), a second surface 310B (e.g., a rear surface), and a third surface 310C (e.g., a side surface) enclosing a space between the first surface 310A and the second surface 310B. The first surface 310A may be formed by a first plate 311A of which at least a portion is substantially transparent. For example, the first plate 311A may include a polymer plate or a glass plate including at least one coating layer. The second surface 310B may be formed by a second plate 311B that is substantially opaque. For example, the second plate 311B may be formed of coated or tinted glass, ceramic, polymer, metal (e.g., aluminum, stainless steel (STS), or magnesium), or a combination thereof. The third surface 310C may be formed by a frame 311C that is coupled to the first plate 311A and the second plate 311B and includes a metal and/or a polymer. The second plate 311B and the frame 311C may be formed monolithically. The second plate 311B and the frame 311C may be formed of substantially the same material (e.g., aluminum).

The electronic device 301 may include an input module 350 (e.g., the input module 150 of FIG. 1). The input module 350 may be disposed on the third surface 310C. The input module 350 may include at least one key input device. For example, the key input device may include one or more mechanical actuators (e.g., buttons), one or more capacitors, and/or one or more inductors.

The electronic device 301 may include a sound output module 355 (e.g., the sound output module 155 of FIG. 1). The sound output module 355 may be disposed on the third surface 310C. The sound output module 355 may include one or more holes.

The electronic device 301 may include a display module 361 (e.g., the display module 160 of FIG. 1). The display module 361 may be disposed on the first surface 310A. The display module 361 may be visible through at least a portion of the first plate 311A. The display module 361 may have a shape that is substantially the same as the shape of an outer edge of the first plate 311A. The periphery of the display module 361 may substantially coincide with the outer edge of the first plate 311A. The display module 361 may include a touch sensing circuit, a pressure sensor for measuring the intensity (pressure) of a touch, and/or a digitizer for detecting a magnetic-type stylus pen. The display module 361 may include a screen display area 361A that is visually exposed to display content using pixels. The screen display area 361A may include a sensing area 361A-1. The sensing area 361A-1 may overlap at least a partial area of the screen display area 361A. The sensing area 361A-1 may allow transmission of an input signal related to a sensor module 376 (e.g., the sensor module 176 of FIG. 1). The sensing area 361A-1 may display content, like the screen display area 361A that does not overlap the sensing area 361A-1. For example, the sensing area 361A-1 may display the content while the sensor module 376 is not operating. At least a portion of a camera area 361A-2 may overlap the screen display area 361A. The screen display area 361A may include the camera area 361A-2. The camera area 361A-2 may allow transmission of an optical signal related to a first camera module 380A (e.g., the camera module 180 of FIG. 1 and/or the camera module 180 of FIG. 2). The camera area 361A-2 may also be referred to as a “display hole”. The camera area 361A-2 may have a substantially circular or oval shape. In one or more embodiments, the display module 361 may include one or more of an audio module 370, the sensor module 376, the first camera module 380A, or a light-emitting element on a rear surface (e.g., a −Z direction surface) of the screen display area 361A. For example, in the electronic device 301, a camera module (e.g., the first camera module 380A) may be disposed on a rear surface of at least one of the first surface 310A (e.g., the front surface) or the third surface 310C (e.g., the side surface), facing the first surface 310A and/or the third surface 310C. For example, the first camera module 380A may not be visually exposed to the display area 361A and may include an under display camera (UDC), which may also be referred to as an under panel camera (UPC).

The electronic device 301 may include the audio module 370 (e.g., the audio module 170 of FIG. 1). The audio module 370 may be disposed on the third surface 310C. The audio module 370 may obtain a sound through at least one hole.

The electronic device 301 may include the sensor module 376. The sensor module 376 may be disposed on the first surface 310A. The sensor module 376 may form the sensing area 361A-1 in at least a portion of the screen display area 361A. The sensor module 376 may receive an input signal transmitted through the sensing area 361A-1 and generate an electrical signal based on the received input signal. For example, the input signal may have a designated physical quantity (e.g., heat, light, temperature, sound, pressure, or ultrasound). The input signal may include a signal related to biometric information (e.g., a fingerprint) of a user.

The electronic device 301 may include a connecting terminal 378 (e.g., the connecting terminal 178 of FIG. 1). The connecting terminal 378 may be disposed on the third surface 310C. For example, when the electronic device 301 is viewed in one direction (e.g., the Y-axis direction), the connecting terminal 378 may be positioned substantially in a central portion of the third surface 310C, and the sound output module 355 may be positioned on one side (e.g., the right side) with respect to the connecting terminal 378.

The electronic device 301 may include the first camera module 380A (e.g., the camera module 180 of FIG. 1 and/or the camera module 180 of FIG. 2). The first camera module 380A may be disposed on the first surface 310A. At least a portion of the first camera module 380A may be disposed under the display module 361. The first camera module 380A may receive an optical signal transmitted through the camera area 361A-2.

The electronic device 301 may include a plurality of second camera modules 380B (e.g., the camera module 180 of FIG. 1 and/or the camera module 180 of FIG. 2). The plurality of second camera modules 380B may be disposed on the second surface 310B. The plurality of second camera modules 380B may be arranged in a first row in one direction (e.g., the Y-axis direction) of the second plate 311B. The plurality of second camera modules 380B may have different fields of view. For example, the plurality of second camera modules 380B may include an ultra-wide-angle camera, a wide-angle camera, and/or a tele camera.

The electronic device 301 may include a light module 380C (e.g., the flash 220 of FIG. 2). The light module 380C may be arranged in a second row substantially parallel to the first row of the plurality of second camera modules 380B on the second surface 310B. The light module 380C may include one or more light-emitting diodes or xenon lamps. The light module 380C may include a sensor configured to detect external light. For example, the sensor may include a flicker sensor.

The electronic device 301 may include a third camera module 380D. The pixel, magnification, and/or field of view of the third camera module 380D may differ from the pixel, magnification, and/or field of view of at least one second camera module 380B. The third camera module 380D may be arranged in the second row substantially parallel to the first row of the plurality of second camera modules 380B on the second surface 310B.

The electronic device 301 may include a fourth camera module 380E. The fourth camera module 380E, which may also be referred to as a “depth camera” or a “time-of-flight (ToF) camera”, may be configured to measure the distance between the fourth camera module 380E and an object. For example, the fourth camera module 380E may be configured to measure the distance using at least one or a combination of an ultrasonic wave, an infrared ray, or a laser. The fourth camera module 380E may be arranged in the second row substantially parallel to the first row of the plurality of second camera modules 380B on the second surface 310B.

The aspects and features described herein may also apply to electronic devices of various shapes/forms (e.g., a foldable electronic device, a slidable electronic device, a rollable electronic device, a digital camera, a digital video camera, a tablet PC, a laptop computer, and other electronic devices), in addition to the electronic device shown in FIGS. 3 and 4.

As used herein, the terms “substantially”, “approximately”, “generally”, and “about” in reference to a given parameter, property, or condition may include a degree that one of ordinary skill in the art would understand that the given parameter, property, or condition is met with a small degree of variance, such as within acceptable manufacturing tolerances. For example, a parameter that is substantially met may be at least 90% met, at least 95% met, or at least 99% met.

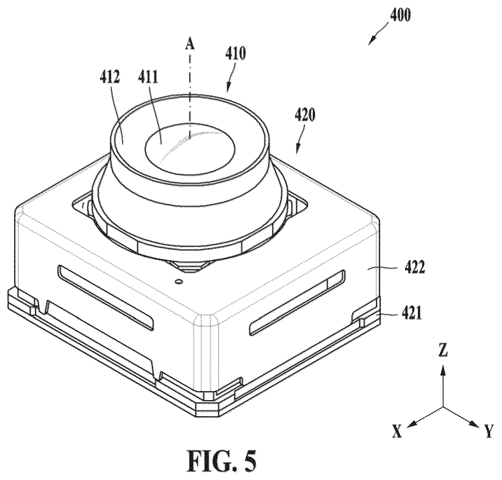

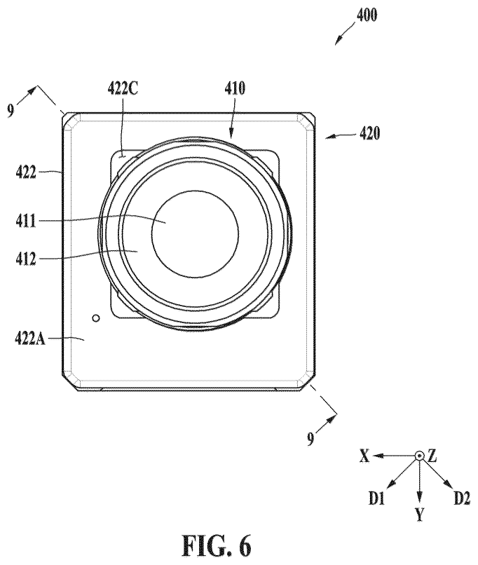

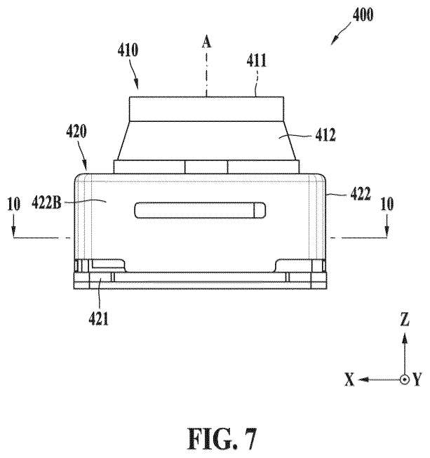

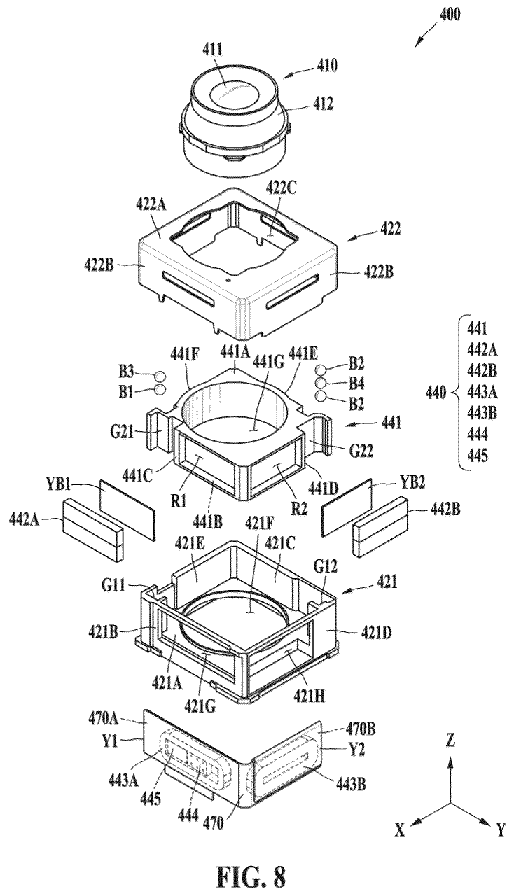

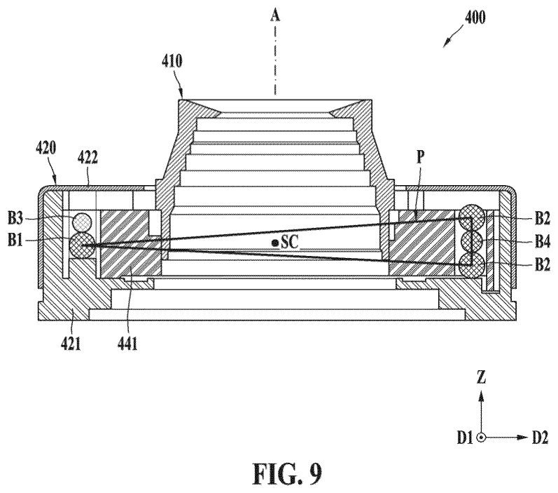

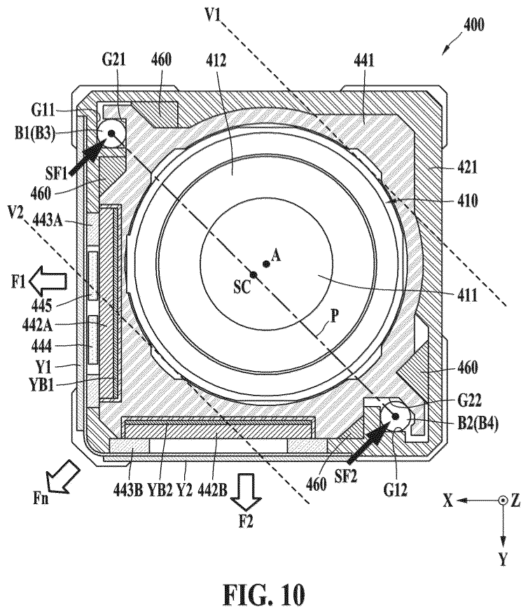

FIG. 5 is a perspective view of a camera module according to one or more embodiments. FIG. 6 is a plan view of a camera module according to one or more embodiments. FIG. 7 is a side view of a camera module according to one or more embodiments. FIG. 8 is an exploded perspective view of a camera module according to one or more embodiments. FIG. 9 is a cross-sectional view of the camera module along line 9-9 of FIG. 6 according to one or more embodiments. FIG. 10 is a cross-sectional view of the camera module along line 10-10 of FIG. 7 according to one or more embodiments.

Referring to FIGS. 5 to 10, a camera module 400 (e.g., the camera module 180 of FIG. 1, the camera module 180 of FIG. 2, and/or the second camera module 380B of FIGS. 3 and 4) may include a lens assembly 410 (e.g., the lens assembly 210 of FIG. 2). The lens assembly 410 may include at least one lens 411 having a defined optical axis A. A portion of the optical axis A may be defined as a line connecting the center of curvature of a first surface and the center of curvature of an Nth surface (where N is a natural number) of the at least one lens 411. The lens assembly 410 may include a lens housing 412 configured to accommodate the at least one lens 411. The lens housing 412 may also be referred to as a “lens barrel”.

The camera module 400 may include a camera housing 420. The camera housing 420 may be configured to accommodate one or more camera-related components. The camera housing 420 may include a base frame 421 and a cover frame 422 configured to cover the base frame 421.

The base frame 421 may include a bottom portion 421A and a plurality of side walls 421B, 421C, 421D, and 421E connected to the bottom portion 421A. The plurality of side walls 421B, 421C, 421D, and 421E may include a first side wall 421B (e.g., a +X direction side wall), a second side wall 421C (e.g., a −X direction side wall) opposite to the first side wall 421B, a third side wall 421D (e.g., a +Y direction side wall) connecting the first side wall 421B and the second side wall 421C and positioned between the first side wall 421B and the second side wall 421C, and a fourth side wall 421E (e.g., a −Y direction side wall) opposite to the third side wall 421D, connecting the first side wall 421B and the second side wall 421C and positioned between the first side wall 421B and the second side wall 421C.

The bottom portion 421A may include a first center hole 421F that allows light passing through the at least one lens 411 to pass through to an image sensor. The first side wall 421B may include a first hole 421G defined within the first side wall 421B. The third side wall 421D may include a second hole 421H defined within the third side wall 421D.

The base frame 421 may include a first guide G11 configured to guide a first ball B1 and a third ball B3. The first guide G11 may be disposed in a corner area between the first side wall 421B and the fourth side wall 421E. The first guide G11 may be opened toward the second side wall 421C. For example, the first guide G11 may include a generally V-shaped groove that contacts the first ball B1 and the third ball B3 at a first inscribed angle (e.g., about 45 degrees).

The base frame 421 may include a second guide G12 configured to guide a plurality of second balls B2 and a fourth ball B4. The second guide G12 may be disposed in a corner area between the second side wall 421C and the third side wall 421D. The second guide G12 may be opened toward the fourth side wall 421E. For example, the second guide G12 may include a generally V-shaped groove that contacts the plurality of second balls B2 and the fourth ball B4 at a second inscribed angle (e.g., about 45 degrees).

The camera housing 420 may include the cover frame 422, which may be referred to as a “shield can.” The cover frame 422 may include a top portion 422A, a plurality of second side walls 422B connected to the top portion 422A, and a third hole 422C disposed in the top portion 422A. The lens housing 412 may at least partially pass through the third hole 422C.

The camera module 400 may include an image sensor and a PCB configured to transmit electrical signals converted from the image sensor to other components (e.g., the processor 120 of FIG. 1 and/or the image signal processor 260 of FIG. 2).

The camera module 400 may include an actuator 440 configured to drive the at least one lens 411 in a direction (e.g., a Z-axis direction) along the optical axis A. The actuator 440 may be referred to as an “autofocus (AF) actuator.”

The actuator 440 may include a carrier 441 configured to carry the lens housing 412 in a direction (e.g., the Z-axis direction) along the optical axis A. The carrier 441 may be referred to as an “AF carrier.” The carrier 441 may include a first carrier surface 441A (e.g., a +Z direction carrier surface), a second carrier surface 441B (e.g., a −Z direction carrier surface) opposite to the first carrier surface 441A, and a plurality of outer side carrier surfaces 441C, 441D, 441E, and 441F between the first carrier surface 441A and the second carrier surface 441B. The plurality of outer side carrier surfaces 441C, 441D, 441E, and 441F may include a first outer side carrier surface 441C facing a first direction (e.g., an X-axis direction) substantially orthogonal to the optical axis A, a second outer side carrier surface 441D facing a second direction (e.g., a Y-axis direction) substantially orthogonal to the optical axis A and different (e.g., orthogonal to the first direction) from the first direction, a third outer side carrier surface 441E opposite to the first outer side carrier surface 441C, and a fourth outer side carrier surface 441F opposite to the second outer side carrier surface 441D.

The carrier 441 may include a first recess R1 recessed in the first outer side carrier surface 441C, and a second recess R2 recessed in the second outer side carrier surface 441D.

The carrier 441 may include a second center hole 441G passing through the first carrier surface 441A and the second carrier surface 441B. The lens housing 412 may at least partially pass through the second center hole 441G. In one or more embodiments, the lens housing 412 and the carrier 441 may be configured as an integral component. The integral component may be referred to as a lens holder, lens housing, or carrier.

The carrier 441 may include a third guide G21 configured to guide the first ball B1 and the third ball B3 together with the first guide G11. The third guide G21 may be disposed in a corner area between the first outer side carrier surface 441C and the fourth outer side carrier surface 441F. The third guide G21 may be opened toward the first side wall 421B. For example, the third guide G21 may include a generally V-shaped groove that contacts the first ball B1 and the third ball B3 at a third inscribed angle (e.g., about 45 degrees).

The carrier 441 may include a fourth guide G22 configured to guide the plurality of second balls B2 and the fourth ball B4 together with the second guide G12. The fourth guide G22 may be disposed in a corner area between the second outer side carrier surface 441D and the third outer side carrier surface 441E. The fourth guide G22 may be opened toward the third side wall 421D. For example, the fourth guide G22 may include a generally V-shaped groove configured to guide the plurality of second balls B2 and the fourth ball B4 at a fourth inscribed angle (e.g., about 45 degrees).

The actuator 440 may include a first magnet 442A. The first magnet 442A may be a unipolar magnet magnetized in a direction along the optical axis A. The first magnet 442A may be disposed in the first recess R1. The actuator 440 may include a second magnet 442B. The second magnet 442B may be a unipolar magnet magnetized in the direction along the optical axis A. The second magnet 442B may be disposed in the second recess R2.

The actuator 440 may include a first coil 443A configured to be electromagnetically coupled with the first magnet 442A. When current flows through the first coil 443A, a driving force in a direction substantially parallel to the optical axis A may be generated in the first magnet 442A. The first coil 443A may be disposed in the first hole 421G. The actuator 440 may include a second coil 443B configured to be electromagnetically coupled with the second magnet 442B. When current flows through the second coil 443B, a driving force in the direction substantially parallel to the optical axis A may be generated in the second magnet 442B. The second coil 443B may be disposed in the second hole 421H. The actuator 440 including multiple pairs of driving portions, including the first magnet 442A and the first coil 443A, and the second magnet 442B and the second coil 443B, may maintain or reduce current consumption during image acquisition. Since the desired driving force of the actuator 440 may be easily achieved, the height of the camera module 400 may be maintained or reduced.

The actuator 440 may include a sensor 444 configured to detect a magnetic flux density of the first magnet 442A. For example, the sensor 444 may include a hall sensor or a tunnel magneto-resistance sensor. The sensor 444 may be disposed inside the first coil 443A. In one or more embodiments, the sensor 444 may be configured to detect the magnetic flux density of the second magnet 442B. The sensor 444 may be disposed inside the second coil 443B.

The actuator 440 may include a first back yoke YB1 configured to attract the first magnet 442A. The first back yoke YB1 may allow the first magnet 442A to be fixed to the first recess R1. The first back yoke YB1 may be disposed between the first recess R1 and the first magnet 442A. The actuator 440 may include a second back yoke YB2 configured to attract the second magnet 442B. The second back yoke YB2 may allow the second magnet 442B to be fixed to the second recess R2. The second back yoke YB2 may be disposed between the second recess R2 and the second magnet 442B.

The actuator 440 may include a first yoke Y1 configured to attract the first magnet 442A in a first direction (e.g., a +X direction) substantially orthogonal to the optical axis A. The first yoke Y1 may be disposed on a first substrate area 470A of a flexible printed circuit board (FPCB) 470 such that it faces the first magnet 442A while positioning the first coil 443A between the first yoke Y1 and the first magnet 442A.

The actuator 440 may include a second yoke Y2 configured to attract the second magnet 442B in a second direction (e.g., a +Y direction) that is different (e.g., orthogonal to the first direction) from the first direction substantially orthogonal to the optical axis A. The second yoke Y2 may be disposed on a second substrate area 470B of the FPCB 470 such that it faces the second magnet 442B while positioning the second coil 443B between the second yoke Y2 and the second magnet 442B.

A first attractive force F1 between the first magnet 442A and the first yoke Y1 and a second attractive force F2 between the second magnet 442B and the second yoke Y2 may reduce the shaking (e.g., tilting) of the carrier 441 in a direction other than the direction (e.g., the Z-axis direction) along the optical axis A, thereby enabling the actuator 440 having a high spring constant and high driving force to be implemented. When an external impact is applied to the camera module 400, the control of the actuator 440 may become easier, thereby improving the quality of an acquired image.

The actuator 440 may include a metal piece 445. The attractive force between the metal piece 445 and the first magnet 442A may vary depending on a position and/or area of the metal piece 445. Accordingly, the position of the center of suction SC on which a suction resultant force Fn of the first attractive force F1 between the first magnet 442A and the first yoke Y1 and the second attractive force F2 between the second magnet 442B and the second yoke Y2 acts may vary. The metal piece 445 may be disposed inside the first coil 443A. The metal piece 445 may be fixed to the first substrate area 470A of the FPCB 470. In one or more embodiments, the metal piece 445 may be disposed inside the second coil 443B. The metal piece 445 may be fixed to the second substrate area 470B of the FPCB 470. In one or more embodiments, the actuator 440 may include a plurality of the metal pieces 445. The plurality of metal pieces 445 may be respectively disposed inside the first coil 443A and inside the second coil 443B. The plurality of metal pieces 445 may be respectively fixed to the first substrate area 470A and the second substrate area 470B of the FPCB 470.

The camera module 400 may include the first ball B1 configured to guide the carrier 441 with respect to the base frame 421 in a direction (e.g., the Z-axis direction) along the optical axis A. The first ball B1 may be disposed in the first guide G11 and the third guide G21. The camera module 400 may include the plurality of second balls B2 configured to guide the carrier 441 with respect to the base frame 421 in the direction (e.g., the Z-axis direction) along the optical axis A. The plurality of second balls B2 may be disposed in the second guide G12 and the fourth guide G22. The first ball B1 and the plurality of second balls B2 may be configured to support the carrier 441 with respect to the base frame 421 in a direction opposite to the suction resultant force Fn of the first attractive force F1 and the second attractive force F2 with a first support force SF1 and a second support force SF2, respectively. The center of suction SC on which the suction resultant force Fn acts may be offset from the optical axis A and may be located within a virtual shape P (e.g., a triangle) that may be referred to as a “virtual support surface” connecting the first ball B1 and the plurality of second balls B2. The virtual shape P may cross at least a portion of the lens 411. This may reduce the distance between the center of gravity and the center of suction SC of the carrier 441, and reduce the shaking (e.g., tilting) of the carrier 441 in a direction different from the direction along the optical axis A when the carrier 441 is driven in the direction (e.g., the Z-axis direction) along the optical axis A.

The camera module 400 may include the third ball B3. The third ball B3 may be disposed in the first guide G11 and the third guide G21. The size of the third ball B3 may be determined to define a desired operating distance of the first ball B1. For example, the size of the third ball B3 may be substantially the same as or smaller than the size of the first ball B1.

The camera module 400 may include the fourth ball B4. The fourth ball B4 may be disposed in the second guide G21 and the fourth guide G22. The fourth ball B4 may be disposed between adjacent second balls B2 to define a space between the plurality of second balls B2. The fourth ball B4 may increase the space between the second balls B2 to increase the size of the virtual shape P connecting the first ball B1 and the plurality of second balls B2, thereby reducing the possibility of shaking (e.g., tilting) of the carrier 441. For example, the size of the fourth ball B4 may be substantially the same as or smaller than the size of the second ball B2.

The camera module 400 may include a plurality of dampers 460 configured to damp the movement of the carrier 441 in the direction (e.g., the Z-axis direction) along the optical axis A with respect to the base frame 421. The plurality of dampers 460 may include a viscoelastic material. For example, the plurality of dampers 460 may include a high-viscosity gel-like elastomeric material. The plurality of dampers 460 may be disposed in a plurality of clearance spaces between the base frame 421 and the carrier 441. For example, the plurality of dampers 460 may be disposed between clearance spaces around the first guide G11 and the third guide G21 and clearance spaces around the second guide G12 and the fourth guide G22.

The plurality of dampers 460 may be disposed close to the virtual shape P. For example, the plurality of dampers 460 may be disposed in a clearance space between the base frame 421 and the carrier 441 between the virtual shape P and a first virtual contact surface V1 that is substantially parallel to the virtual shape P and in contact with the lens housing 412. The plurality of dampers 460 may be disposed in a clearance space between the base frame 421 and the carrier 441 between the virtual shape P and a second virtual contact surface V2 that is opposite to the first virtual contact surface V1 with respect to the virtual shape P and is substantially parallel to the virtual shape P and in contact with the lens housing 412. A structure in which the plurality of dampers 460 is disposed close to the virtual shape P may reduce or prevent tilting of the lens 411 due to the plurality of dampers 460.

The plurality of dampers 460 may be disposed substantially symmetrically with respect to the virtual shape P. This may reduce or prevent tilting of the lens 411 due to the plurality of dampers 460.

The camera module 400 may include the FPCB 470. The FPCB 470 may at least partially surround a side of the base frame 421. The FPCB 470 may include the first substrate area 470A disposed on the first side wall 421B, and the second substrate area 470B facing the third side wall 421D. The first coil 443A, the sensor 444, and the metal piece 445 may be disposed in the first substrate area 470A, and the second coil 443B may be disposed in the second substrate area 470B. The first coil 443A may be electrically connected to the first substrate area 470A, and the second coil 443B may be electrically connected to the second substrate area 470B.

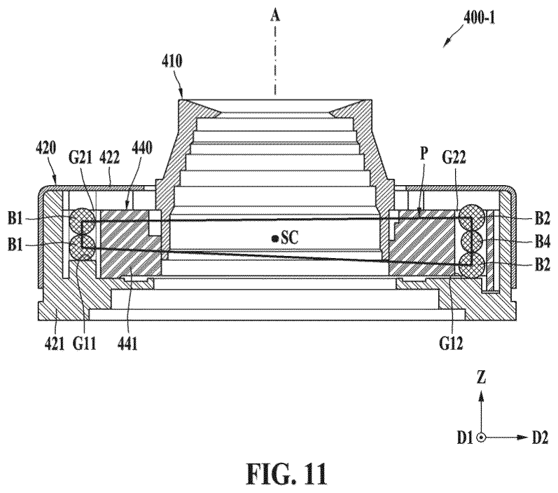

FIG. 11 is a cross-sectional view of a camera module according to one or more embodiments.

Referring to FIG. 11, a camera module 400-1 (e.g., the camera module 180 of FIG. 1, the camera module 180 of FIG. 2, the second camera module 380B of FIGS. 3 and 4, and/or the camera module 400 of FIGS. 5 to 10) may include the lens assembly 410, the camera housing 420, and the actuator 440. The camera housing 420 may include the base frame 421 and the cover frame 422. The base frame 421 may include the first guide G11 and the second guide G12. The actuator 440 may include the carrier 441. The carrier 441 may include the third guide G21 and the fourth guide G22.

The camera module 400-1 may include a plurality of first balls B1 disposed in the first guide G11 and the third guide G21, and the plurality of second balls B2 and the fourth ball B4 disposed in the second guide G12 and the fourth guide G22. The virtual shape P connecting the plurality of first balls B1 and the plurality of second balls B2 may include a trapezoidal shape. The center of suction SC may be located inside the virtual shape P having a trapezoidal shape.

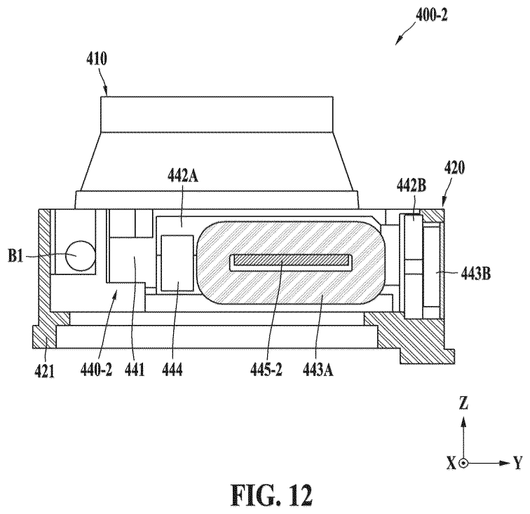

FIG. 12 is a side view of a camera module according to one or more embodiments.

Referring to FIG. 12, a camera module 400-2 (e.g., the camera module 180 of FIG. 1, the camera module 180 of FIG. 2, the second camera module 380B of FIGS. 3 and 4, the camera module 400 of FIGS. 5 to 10, and/or the camera module 400-1 of FIG. 11) may include the lens assembly 410, the camera housing 420, and an actuator 440-2 (e.g., the actuator 440 of FIGS. 5 to 10 and/or the actuator 440 of FIG. 11). The actuator 440-2 may include the carrier 441, the first magnet 442A, the second magnet 442B, the first coil 443A, the second coil 443B, the sensor 444, a metal piece 445-2 (e.g., the metal piece 445 of FIGS. 5 to 10), and at least one ball (e.g., the first ball B1).

The sensor 444 may be disposed on the outside of the first coil 443A. The metal piece 445-2 may extend along a length direction (e.g., a Y-axis direction) of the center slot of the first coil 443A. The metal piece 445-2 may be disposed on a side (e.g., a +Z direction side) of the center slot of the first coil 443A.

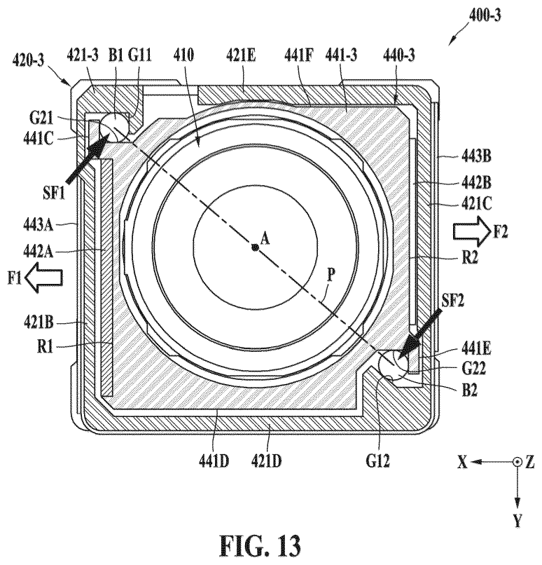

FIG. 13 is a plan view of a camera module according to one or more embodiments.

Referring to FIG. 13, a camera module 400-3 (e.g., the camera module 180 of FIG. 1, the camera module 180 of FIG. 2, the second camera module 380B of FIGS. 3 and 4, the camera module 400 of FIGS. 5 to 10, the camera module 400-1 of FIG. 11, and/or the camera module 400-2 of FIG. 12) may include the lens assembly 410, a camera housing 420-3 (e.g., the camera housing 420 of FIGS. 5 to 10, the camera housing 420 of FIG. 11, and/or the camera housing 420 of FIG. 12), and an actuator 440-3 (e.g., the actuator 440 of FIGS. 5 to 10, the actuator 440 of FIG. 11, and/or the actuator 440-2 of FIG. 12).

The camera housing 420-3 may include a base frame 421-3 (e.g., the base frame 421 of FIGS. 5 to 10 and/or the base frame 421 of FIG. 11). The base frame 421-3 may include the first side wall 421B, the second side wall 421C, the third side wall 421D, and the fourth side wall 421E. The base frame 421-3 may include the first guide G11 disposed inside the fourth side wall 421E and open toward the first side wall 421B and the third side wall 421D, and the second guide G12 disposed inside the third side wall 421D and open toward the second side wall 421C and the fourth side wall 421E.

The actuator 440-3 may include a carrier 441-3 (e.g., the carrier 441 of FIG. 5 to 10, the carrier 441 of FIG. 11, and/or the carrier 441 of FIG. 12). The carrier 441-3 may include the first outer side carrier surface 441C, the second outer side carrier surface 441D, the third outer side carrier surface 441E, and the fourth outer side carrier surface 441F. The carrier 441-3 may include the third guide G21 disposed in a corner area between the first outer side carrier surface 441C and the fourth outer side carrier surface 441F and open toward the fourth side wall 421E, and the fourth guide G22 disposed in a corner area between the second outer side carrier surface 441D and the third outer side carrier surface 441E and open toward the third side wall 421D. The carrier 441-3 may include the first recess R1 recessed in the first outer side carrier surface 441C, and the second recess R2 recessed in the third outer side carrier surface 441E.

The camera module 400-3 may include the first ball B1 disposed in the first guide G11 and the third guide G21, and the plurality of second balls B2 disposed in the second guide G21 and the fourth guide G22.

The actuator 440-3 may include the first magnet 442A disposed in the first recess R1, the second magnet 442B disposed in the second recess R2 opposite to the first magnet 442A, the first coil 443A disposed on the first side wall 421B and facing the first magnet 442A, and the second coil 443B disposed on the second side wall 421C and facing the second magnet 442B. The symmetrical structure of the first magnet 442A and the second magnet 442B may allow the center of gravity of the optical axis A and the carrier 441-3 to pass through a virtual shape P connecting the first ball B1 and the plurality of second balls B2.

The first magnet 442A may be offset adjacent to the second outer side carrier surface 441D in a direction (e.g., a Y-axis direction) substantially orthogonal to a direction (e.g., a Z-axis direction) along the optical axis A and a direction (e.g., an X-axis direction) between the first magnet 442A and the second magnet 442B. The second magnet 442B may be offset adjacent to the fourth outer side carrier surface 441F in a direction (e.g., the Y-axis direction) substantially orthogonal to a direction (e.g., the Z-axis direction) along the optical axis A and a direction (e.g., the X-axis direction) between the first magnet 442A and the second magnet 442B. The offset structure of the first magnet 442A and the second magnet 442B may cause rotation (e.g., clockwise or counterclockwise rotation about the Z-axis) of the carrier 441-3 about the optical axis A. To reduce or prevent the rotation of the carrier 441-3, the first ball B1 may support the carrier 441-3 with respect to the base frame 421-3 with a first support force SF1 in an opposite direction to the rotation, and the plurality of second balls B2 may support the carrier 441-3 with respect to the base frame 421-3 with a second support force SF2 in an opposite direction to the rotation.

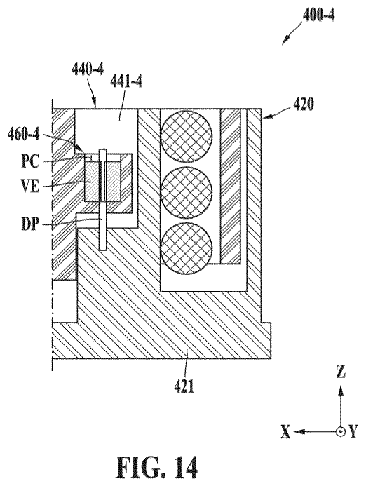

FIG. 14 is a cross-sectional view of a damper of a camera module according to one or more embodiments.

Referring to FIG. 14, a camera module 400-4 (e.g., the camera module 180 of FIG. 1, the camera module 180 of FIG. 2, the second camera module 380B of FIGS. 3 and 4, the camera module 400 of FIGS. 5 to 10, the camera module 400-1 of FIG. 11, the camera module 400-2 of FIG. 12, and/or the camera module 400-3 of FIG. 13) may include the camera housing 420, an actuator 440-4 (e.g., the actuator 440 of FIGS. 5 to 10, the actuator 440 of FIG. 11, the actuator 440-2 of FIG. 12, and/or the actuator 440-3 of FIG. 13), and a damper 460-4 (e.g., the damper 460 of FIGS. 5 to 10). The camera housing 420 may include the base frame 421.

The actuator 440-4 may include a carrier 441-4 (e.g., the carrier 441 of FIG. 5 to 10, the carrier 441 of FIG. 11, the carrier 441 of FIG. 12, and/or the carrier 441-3 of FIG. 13). The carrier 441-4 may include a pocket PC configured to at least partially accommodate the damper 460-4. The pocket PC may consist of an enclosure closed entirely by four surfaces (e.g., a +Z direction surface, a −Z direction surface, a +X direction surface, and a −X direction surface). The damper 460-4 may include a viscoelastic material VE disposed inside the pocket PC, and a damper pin DP connected to the carrier 441-4 and the base frame 421 through a hole disposed in the pocket PC and penetrating the viscoelastic material VE along an optical axis (e.g., a Z-axis) and across the pocket PC. In one or more embodiments, the base frame 421 may include the pocket PC.

The damper 460-4 described with reference to FIG. 14 is not limited to the illustrated embodiment and may be implemented in various structures/schemes.

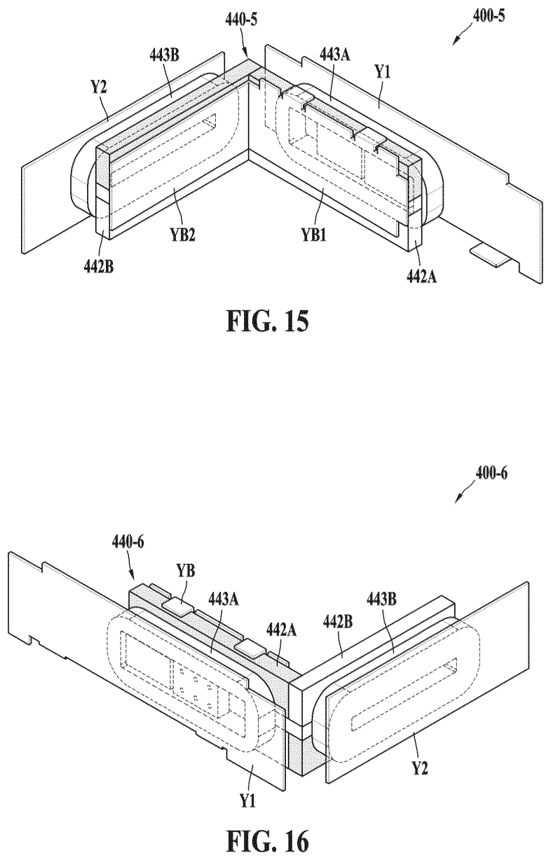

FIG. 15 is a perspective view of a magnet and a yoke of a camera module according to one or more embodiments.

Referring to FIG. 15, a camera module 400-5 (e.g., the camera module 180 of FIG. 1, the camera module 180 of FIG. 2, the second camera module 380B of FIGS. 3 and 4, the camera module 400 of FIGS. 5 to 10, the camera module 400-1 of FIG. 11, the camera module 400-2 of FIG. 12, the camera module 400-3 of FIG. 13, and/or the camera module 400-4 of FIG. 14) may include an actuator 440-5 (e.g., the actuator 440 of FIGS. 5 to 10, the actuator 440 of FIG. 11, the actuator 440-2 of FIG. 12, the actuator 440-3 of FIG. 13, and/or the actuator 440-4 of FIG. 14). The actuator 440-5 may include the first magnet 442A, the second magnet 442B, the first coil 443A, the second coil 443B, the first back yoke YB1, the second back yoke YB2, the first yoke Y1, and the second yoke Y2. A magnetization direction of the first magnet 442A and a magnetization direction of the second magnet 442B may be the same when viewed in a direction along an optical axis. The first magnet 442A and the second magnet 442B may be physically coupled to each other. This may simplify the inspection and assembly of the components of the actuator 440-5. The first back yoke YB1 and the second back yoke YB2 may be integrally and seamlessly connected to each other. This may simplify the inspection and assembly of the components of the actuator 440-5.

FIG. 16 is a perspective view of a magnet and a yoke of a camera module according to one or more embodiments.

Referring to FIG. 16, a camera module 400-6 (e.g., the camera module 180 of FIG. 1, the camera module 180 of FIG. 2, the second camera module 380B of FIGS. 3 and 4, the camera module 400 of FIGS. 5 to 10, the camera module 400-1 of FIG. 11, the camera module 400-2 of FIG. 12, the camera module 400-3 of FIG. 13, and/or the camera module 400-4 of FIG. 14) may include an actuator 440-6 (e.g., the actuator 440 of FIGS. 5 to 10, the actuator 440 of FIG. 11, the actuator 440-2 of FIG. 12, the actuator 440-3 of FIG. 13, and/or the actuator 440-4 of FIG. 14). The actuator 440-6 may include the first magnet 442A, the second magnet 442B, the first coil 443A, the second coil 443B, a back yoke YB, the first yoke Y1, and the second yoke Y2. The back yoke YB may be configured as an integral structure that absorbs both the first magnet 442A and the second magnet 442B. A magnetization direction of the first magnet 442A and a magnetization direction of the second magnet 442B may be opposite to each other when viewed in a direction along an optical axis. This may reduce the leakage flux of the actuator 440-6.

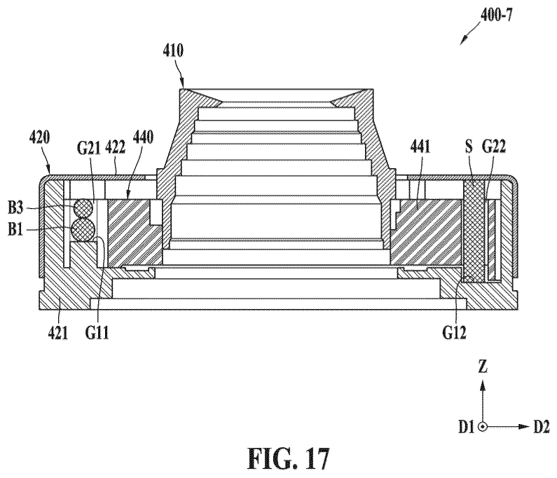

FIG. 17 is a cross-sectional view of a camera module according to one or more embodiments.

Referring to FIG. 17, a camera module 400-7 (e.g., the camera module 180 of FIG. 1, the camera module 180 of FIG. 2, the second camera module 380B of FIGS. 3 and 4, the camera module 400 of FIGS. 5 to 10, the camera module 400-1 of FIG. 11, the camera module 400-2 of FIG. 12, the camera module 400-3 of FIG. 13, the camera module 400-4 of FIG. 14, the camera module 400-5 of FIG. 15, and/or the camera module 400-6 of FIG. 16) may include the lens assembly 410, the camera housing 420, and the actuator 440. The camera housing 420 may include the base frame 421 and the cover frame 422. The base frame 421 may include the first guide G11 and the second guide G12. The actuator 440 may include the carrier 441. The carrier 441 may include the third guide G21 and the fourth guide G22.

The camera module 400-7 may include the first ball B1 and the third ball B3 disposed in the first guide G11 and the third guide G21. The camera module 400-7 may include a shaft S. The shaft S may extend from the base frame 421 toward the cover frame 422. The shaft S may be disposed in the second guide G12 and the fourth guide G22. The shaft S may ensure linear movement along the optical axis A of the carrier 441. Partially guiding the carrier 441 with the shaft S may reduce the frictional force applied to the carrier 441 while reducing the shaking (e.g., tilting) of the carrier 441 when the carrier 441 moves in the direction along the optical axis A, thereby reducing a driving load due to the frictional force.

An aspect of the disclosure is to provide an actuator that reduces vibration that may occur in a camera module when an external impact is applied to the camera module, and a camera module including the actuator. The technical goals to be achieved are not limited to those described above, and other technical goals not mentioned above are clearly understood by one of ordinary skill in the art to which the disclosure pertains.

The camera module 400 may include the lens 411 having an optical axis A. The camera module 400 may include the carrier 441 configured to carry the lens 411 in a direction along the optical axis A. The camera module 400 may include the camera housing 420 configured to accommodate the carrier 441. The camera module 400 may include the first magnet 442A disposed in the carrier 441 in a first direction substantially orthogonal to the optical axis A. The camera module 400 may include the second magnet 442B disposed in the carrier 441 in a second direction substantially orthogonal to the optical axis A and different from the first direction. The camera module 400 may include the first coil 443A disposed in the camera housing 420 and configured to be electromagnetically coupled with the first magnet 442A. The camera module 400 may include the second coil 443B disposed in the camera housing 420 and configured to be electromagnetically coupled with the second magnet 442B. The camera module 400 may include a first yoke Y1 disposed in the camera housing 420 and facing the first magnet 442A. The camera module 400 may include a second yoke Y2 disposed in the camera housing 420 and facing the second magnet 442B. The camera module 400 may include at least three balls B1 and B2 disposed between the carrier 441 and the camera housing 420. The at least three balls B1 and B2 may be configured to support the carrier 441 with respect to the camera housing 420 and guide the carrier 441 in a direction along the optical axis A.

The at least three balls B1 and B2 may be configured to support the carrier 441 with respect to the camera housing 420 in a direction opposite to a direction in which a suction resultant force Fn of the first attractive force F1 acting between the first magnet 442A and the first yoke Y1 and the second attractive force F2 acting between the second magnet 442B and the second yoke Y2 acts.

The first direction and the second direction may be substantially orthogonal to each other.

The at least three balls B1 and B2 may include the first ball B1 disposed in a first corner area of the camera housing 420, and the plurality of second balls B2 disposed in a second corner area of the camera housing 420 that is not adjacent to the first corner area. The virtual shape P connecting the first ball B1 and the plurality of second balls B2 may cross at least a portion of the lens 411.

The camera housing 420 may include the first guide G11 configured to guide the first ball B1, and the second guide G12 configured to guide the plurality of second balls B2. The carrier 441 may include the third guide G21 configured to guide the first ball B1, and the fourth guide G22 configured to guide the plurality of second balls B2. At least one of the first guide G11, the second guide G12, the third guide G21 or the fourth guide G22 may include a generally V-shaped groove.

The at least three balls B1 and B2 may further include an additional first ball B1 disposed in the first corner area of the camera housing 420.

The camera module 400 may further include the sensor 444 disposed inside of at least one of the first coil 443A or the second coil 443B.

The camera module 400 may further include the metal piece 445 disposed inside of at least one of the first coil 443A or the second coil 443B.

The camera module 400-2 may further include the sensor 444 disposed on the outside of at least one of the first coil 443A or the second coil 443B.

The first direction may be opposite to the second direction.

The first magnet 442A may be offset in a third direction substantially orthogonal to the first direction and the second direction. The second magnet 442B may be offset in a fourth direction opposite to the third direction.

The optical axis A may pass through the virtual shape P connecting the at least three balls B1, B2, and B3.

The camera module 400 may further include a first damper 460 disposed in a clearance space between the camera housing 420 and the carrier 441 between the virtual shape P and a first virtual contact surface V1 that is substantially parallel to the virtual shape P and in contact with the lens housing 412 configured to accommodate the lens 411.

The camera module 400 may further include a second damper 460 disposed in a clearance space between the camera housing 420 and the carrier 441 between the virtual shape P and a second virtual contact surface V2 that is opposite to the first virtual contact surface V1 with respect to the virtual shape P and is substantially parallel to the virtual shape P and in contact with the lens housing 412. The first damper 460 and the second damper 460 may be disposed substantially symmetrically with respect to the virtual shape P.

The magnetization direction of the first magnet 442A may be the same as the magnetization direction of the second magnet 442B.

The magnetization direction of the first magnet 442A may be opposite to the magnetization direction of the second magnet 442B.

The first magnet 442A may be physically connected to the second magnet 442B.

The camera module 400-6 may further include a single back yoke YB facing the first magnet 442A and the second magnet 442B.

The camera module 400-7 may include the lens 411 having an optical axis A. The camera module 400-7 may include the carrier 441 configured to carry the lens 411 in a direction along the optical axis A. The camera module 400-7 may include the camera housing 420 configured to accommodate the carrier 441. The camera module 400-7 may include the first magnet 442A disposed in the carrier 441 in the first direction substantially orthogonal to the optical axis A. The camera module 400-7 may include the second magnet 442B disposed in the carrier 441 in the second direction substantially orthogonal to the optical axis A and different from the first direction. The camera module 400-7 may include the first coil 443A disposed in the camera housing 420 and configured to be electromagnetically coupled with the first magnet 442A. The camera module 400-7 may include the second coil 443B disposed in the camera housing 420 and configured to be electromagnetically coupled with the second magnet 442B. The camera module 400-7 may include the first yoke Y1 disposed in the camera housing 420 and facing the first magnet 442A. The camera module 400-7 may include the second yoke Y2 disposed in the camera housing 420 and facing the second magnet 442B. The camera module 400-7 may include at least one ball B1 configured to guide the carrier 441 with respect to the camera housing 420 in the direction along the optical axis A. The camera module 400-7 may include a shaft S configured to guide the carrier 441 with respect to the camera housing 420 in the direction along the optical axis A.

The electronic device 101 or 301 may include a camera module 400, 400-1, 400-2, 400-3, 400-4, 400-5, 400-6, or 400-7.

According to one or more embodiments, an actuator having a high spring constant and a high driving force may be implemented so that the actuator may be easily controlled when an external impact is applied to the camera module, thereby improving the quality of an acquired image. According to one or more embodiments, the current consumed during image acquisition may be maintained or reduced. According to one or more embodiments, the height of the camera module may be reduced. The effects of the camera module according to embodiments are not limited to those mentioned above, and other effects not mentioned may be clearly understood by those skilled in the art from the description of the disclosure.

The embodiments of the present disclosure are intended to be illustrative and not restrictive. Various modifications may be made to the detailed description of the disclosure including the accompanying scope of claims and equivalents. Any of the embodiment(s) described herein may be used in combination with the embodiment(s) described herein.

What is claimed is:

1. A camera module comprising:
a lens having an optical axis;
a carrier configured to carry the lens in a direction along the optical axis;
a camera housing configured to accommodate the carrier;
a first magnet in the carrier and offset from the optical axis in a first direction substantially orthogonal to the optical axis;
a second magnet in the carrier and offset from the optical axis in a second direction different from the first direction and substantially orthogonal to the optical axis;
a first coil in the camera housing and configured to be electromagnetically coupled with the first magnet;
a second coil in the camera housing and configured to be electromagnetically coupled with the second magnet;
a first yoke in the camera housing and facing the first magnet;
a second yoke in the camera housing and facing the second magnet; and
at least three balls between the carrier and the camera housing,
wherein the at least three balls are configured to support the carrier with respect to the camera housing and to guide the carrier in the direction along the optical axis.

2. The camera module of claim 1, wherein a first attractive force acting between the first magnet and the first yoke and a second attractive force acting between the second magnet and the second yoke generate a suction resultant force, and
wherein the at least three balls are configured to support the carrier with respect to the camera housing in a direction opposite to a direction in which the suction resultant force acts.

3. The camera module of claim 1, wherein the first direction and the second direction are substantially orthogonal to each other.

4. The camera module of claim 1, wherein the at least three balls comprises:
a first ball in a first corner area of the camera housing; and
a plurality of second balls in a second corner area of the camera housing,
wherein the second corner area is not adjacent to the first corner area, and
wherein a virtual shape connecting the first ball and the plurality of second balls crosses at least a portion of the lens.

5. The camera module of claim 4, wherein the camera housing comprises:
a first guide configured to guide the first ball; and
a second guide configured to guide the plurality of second balls,
wherein the carrier comprises:
a third guide configured to guide the first ball; and
a fourth guide configured to guide the plurality of second balls, and
wherein at least one of the first guide, the second guide, the third guide, or the fourth guide comprises a V-shaped groove.

6. The camera module of claim 4, wherein the at least three balls further comprises an additional first ball in the first corner area of the camera housing.

7. The camera module of claim 1, further comprising:
a sensor inside of at least one of the first coil or the second coil.

8. The camera module of claim 1, further comprising:
a metal piece inside of at least one of the first coil or the second coil.

9. The camera module of claim 1, further comprising:
a sensor on the outside of at least one of the first coil or the second coil.

10. The camera module of claim 1, wherein the first direction is opposite to the second direction.

11. The camera module of claim 10, wherein the first magnet is offset from the optical axis in a third direction substantially orthogonal to the first direction and the second direction, and
wherein the second magnet is offset from the optical axis in a fourth direction opposite to the third direction.

12. The camera module of claim 4, wherein the optical axis passes through the virtual shape connecting the at least three balls.

13. The camera module of claim 12, further comprising:
a lens housing configured to accommodate the lens; and
a first damper in a clearance space between the camera housing and the carrier,
wherein the first damper is between the virtual shape and a first virtual contact surface, and
wherein the first virtual contact surface is substantially parallel to the virtual shape and contacts the lens housing.

14. The camera module of claim 13, further comprising:
a second damper in a clearance space between the camera housing and the carrier,
wherein the second damper is between the virtual shape and a second virtual contact surface on an opposite side of the virtual shape from the first virtual contact surface,
wherein the second virtual contact surface is substantially parallel to the virtual shape and in contact with the lens housing, and
wherein the first damper and the second damper are disposed substantially symmetrically with respect to the virtual shape.

15. The camera module of claim 1, wherein a magnetization direction of the first magnet is the same as a magnetization direction of the second magnet.

16. The camera module of claim 1, wherein a magnetization direction of the first magnet is opposite to a magnetization direction of the second magnet.

17. The camera module of claim 1, wherein the first magnet is physically connected to the second magnet.

18. The camera module of claim 1, further comprising:
a single back yoke facing the first magnet and the second magnet.

19. A camera module comprising:
a lens having an optical axis;
a carrier configured to carry the lens in a direction along the optical axis;
a camera housing configured to accommodate the carrier;
a first magnet in the carrier and offset from the optical axis in a first direction substantially orthogonal to the optical axis;
a second magnet in the carrier and offset from the optical axis in a second direction different from the first direction and substantially orthogonal to the optical axis;
a first coil in the camera housing and configured to be electromagnetically coupled with the first magnet;
a second coil in the camera housing and configured to be electromagnetically coupled with the second magnet;
a first yoke in the camera housing and facing the first magnet;
a second yoke in the camera housing and facing the second magnet;
at least one ball configured to guide the carrier with respect to the camera housing in the direction along the optical axis; and
a shaft configured to guide the carrier with respect to the camera housing in the direction along the optical axis.

20. An electronic device comprising:
memory storing one or more instructions;
at least one processor configured to execute the one or more instructions; and
a camera module comprising:
a lens having an optical axis;
a carrier configured to carry the lens in a direction along the optical axis;
a camera housing configured to accommodate the carrier;
a first magnet in the carrier and offset from the optical axis in a first direction substantially orthogonal to the optical axis;
a second magnet in the carrier and offset from the optical axis in a second direction different from the first direction and substantially orthogonal to the optical axis;
a first coil in the camera housing and configured to be electromagnetically coupled with the first magnet;
a second coil in the camera housing and configured to be electromagnetically coupled with the second magnet;
a first yoke in the camera housing and facing the first magnet;
a second yoke in the camera housing and facing the second magnet;
at least three balls between the carrier and the camera housing; and
an image sensor configured to obtain an image by converting light received through the lens into an electrical signal,
wherein the at least three balls are configured to support the carrier with respect to the camera housing and to guide the carrier in the direction along the optical axis, and
wherein the one or more instructions, when executed by the at least one processor, cause the electronic device to control movement of the carrier in the direction along the optical axis by controlling a flow of current applied to the first coil and the second coil.
